(19) United States
(12) Patent Application Publication
(10) Pub. No.: US 2004/0039755 A1
(43) Pub. Date: Feb. 26, 2004

(54) Metadata relationships

(76) Inventor: Matthew Kunze, Fort Collins, CO (US)

Correspondence Address: THE LAW OFFICES OF WILLIAM W. COCHRAN, LLC, 3555 STANFORD ROAD, SUITE 230, FORT COLLINS, CO, 80525, US

(21) Appl. No.: 10/456,023

(22) Filed: Jun. 5, 2003

Related U.S. Application Data
(60) Provisional application No. 60/386,916, filed on Jun. 5, 2002.

(51) Int. Cl. G06F 17/00

(52) U.S. Cl. 707/104.1

(57) ABSTRACT

Disclosed is a data storage, display, and editing system whereby a large database may be accessed through a series of views, each view being defined by metadata. The metadata includes relationships to other views that may be used for any purpose including navigation from one view to another. The relationships establish a tree of related views that may be traversed in order to capture data that may be taken off line. The relationships may be used to reconstruct records to be committed to a database. The views and relationships allow useful data to be stored for use off line with a minimum of unnecessary data. The relationships are particularly applicable to database applications that are implemented on handheld or other small, remote computing devices.

### CROSS REFERENCE TO RELATED APPLICATIONS

The present application claims the benefit of provisional U.S. patent application serial No. 60/386,916 filed Jun. 5, 2002 by Matthew Kunze and Robert Gilbert entitled “Metadata Relationships,” which is specifically hereby incorporated by reference for all it discloses and teaches.

### BACKGROUND OF THE INVENTION

a. Field of the Invention

The present invention pertains generally to database metadata and specifically to relationships of metadata and their uses in a mobile computing environment.

b. Description of the Background

Computer databases are a ubiquitous part of the infrastructure of modem society. Databases are used throughout industry for tracking and analyzing everything from inventories, client information, accounting information, production schedules, etc. One of the limiting factors in gathering and using the data are the devices necessary to interface to the database. Most database applications are designed with a computer terminal interface in mind.

The computer databases are typically used by-many different users, each with their own specific tasks and differing needs. The database designers must take into account all of the user's diverse needs when designing the database and creating the various interfaces needed by each user. For a factory maintenance database, one user interface may allow the submission of a work order request, and a supervisor may review the work order requests and assign the work orders to various trades or specific tradesmen. A tradesman, such as an electrician, may have the work description for the electrical portion of a specific work order. All of these users access different information and use their information in different ways.

With the advent of hand held computing and wireless infrastructures, various devices are now available to gather information at any location one may desire. For example, a factory with a wireless network may allow maintenance workers to access a maintenance database anywhere in the factory premises. In another example, a salesperson may be able to access a client database using a cellular phone network connected to a hand held computing device while preparing to board an airplane.

The marriage of mobile computing and large databases has created many issues for the application designer. For example, data presentation and collection using a mobile computer, such as a hand held computer with a touch screen interface is much more difficult than with a portable computer with a full size keyboard and screen. In addition, the available memory and computing power on the hand held device is generally much less than with a desktop computer. Another difficulty is the re-synchronizing of the data when it is loaded onto a hand held, updated, and then later updated to the master database.

Using a small interface such as a touch screen display for data display and collection can be difficult and time consuming. With a conventional desktop computer, the user has a large screen and may have several windows open at any one time. In a typical scheme, the user may change from one screen to another easily and intuitively. On a small screen of a hand held computer, only one window may be active at a time. Further, a touch screen interface can be difficult and very slow for data entry compared to a full size keyboard and pointing device on a conventional desktop computer. Many navigation and data entry tasks that are easily performed on a desktop computer can be painfully laborious and tedious on a hand held computer. These problems lead to incomplete data being entered or a lot of wasted time in the use of the hand held computer.

In many applications, it is impractical to have a constant, live connection with the master database. Thusly, a portion of the data may be loaded onto the hand held or other mobile device for the user to perform their tasks. The specific portion of data should be all of the specific data that the user needs for their task, plus any ancillary data that the user might use. The more information that can be made available is generally better, however only the useful information is necessary. In some systems, the large database may be replicated on the hand held or portable device. However, the users will only use those data that are necessary to do their job. Any extra information is unnecessary and takes longer to load onto the hand held, occupies more memory, detracts from the performance of the hand held, and, in essence, adds to the cost and complexity of the system.

The master application database may have a data format and record structure that is not amenable to display on a hand held computer. For the purposes of a specialized user of a database, it may be necessary to reformat the data and data structure to the nature of the specialized user. For a large number of specialized users, the complexities of hard coding different interfaces to the database can be enormous.

When the user has completed their task, the process of updating the data to the main database can be complex. The data need to be transformed into a format that is ready for updating to the main database and all conflicts must be reconciled.

It would therefore be advantageous to provide a methodology for handling data in a mobile computing environment that allows for easy navigation of the data in useful segments. It would be further advantageous if the navigation methods were easily constructed and assisted in gathering useful data for the user. In addition, the methodology should facilitate data synchronization.

### SUMMARY OF THE INVENTION

The present invention overcomes the disadvantages and limitations of the prior art by providing a metadata definition and relationships within different metadata that facilitate the retrieval, storage, display, navigation, and synchronization of data from a large database. The relationships may be defined easily so that a minimum of hard coding is required to create simple navigation mechanisms. Further, the relationships allow navigation to occur in a way that places the information in a format tailored to what the user needs for a certain operation, eliminating time consuming steps. In addition, the relationships assist in the synchronization of data. A thin client on a mobile computing platform may interpret the metadata and the metadata relationships without requiring extensive computing power or memory.

The present invention may therefore comprise a system for using data from a database comprising: at least one client computer; a server computer in communication with said database and said client computer; a plurality of views defined by a plurality of metadata structures, each of said metadata structures comprising: at least one displayable field of said database to be displayed by said view; a query adapted to extract view data from said database to populate said view; and at least one relationship comprising at least one link to another of said plurality of views; a server program adapted to operate on said server computer and for each of said plurality of views, executing said query to extract view data from said database and store said view data on said client computer in a data container, said view data being arranged in said data container in accordance with said plurality of metadata structures; a client program adapted to operate on said client computer and for each of said plurality of views, retrieve said view data from said data container and display said view data on said client computer in accordance with said plurality of views.

The present invention may further comprise a method for using data from a database comprising: providing at least one client computer; providing a server computer in communication with said database and said client computer; defining a plurality of views defined by a plurality of metadata structures, each of said metadata structures comprising: at least one displayable field of said database to be displayed by said view; a query adapted to extract view data from said database to populate said view; and at least one relationship comprising at least one link to another of said plurality of views; for each of said plurality of views, executing said query to extract view data from said database and storing said view data on said client computer in a data container, said view data being arranged in said data container in accordance with said plurality of metadata structures; retrieving said view data from said data container using said client computer; and displaying said view data on said client computer in accordance with said plurality of views.

The present invention may further comprise a method for displaying data on a remote computer comprising: establishing communications between said remote computer and a server computer connected to a first database; providing a plurality of views, each of said views defined by a metadata structure comprising a query and one or more fields; providing at least one relationship defining a link from a first of said plurality of views to a second of said plurality of views; executing said query of said first of said plurality of views against said database to collect first data; traversing from said first of said plurality of views to said second of said plurality of views using said at least one relationship; executing said query for said second of said plurality of views against said database to collect second data; storing said first data and said second data in a second database accessible to said remote computer; ending said communications between said remote computer and said server computer; displaying at least a portion of said second database using said first of said plurality of views; traversing to said second of said plurality of views using said relationship; and displaying at least a portion of said second database using said second view.

The advantages of the present invention are that the metadata relationships may fully define the interactions within several views of a database interface. The relationships allow for simple definitions of interactions between views that may be interpreted by a thin client on a hand held computer. The ease of definition may allow a highly tailored and customized interface to be quickly created for many different users, raising their efficiency in using and capturing data. Further, the relationships may be used for capturing data to be taken offline and reconstructing data when the data is brought back online. The use of the relationships may make the complex tasks of capturing and reconstructing data simple and streamlined while eliminating hard coding.

### BRIEF DESCRIPTION OF THE DRAWINGS

In the drawings,

FIG. 1 is an illustration of a maintenance database system wherein a database is accessed using a master application and a remote user server.

FIG. 2 is an illustration of a transformation of data that is made between the user to the raw data.

FIG. 3 is an illustration of an embodiment of several sets of metadata for an application of a factory maintenance system.

FIG. 4 is an illustration of a screen of an embodiment of the work order view shown in FIG. 3.

FIG. 5 is an illustration of a screen of an embodiment of the work order details view shown in FIG. 3.

FIG. 6 is a flowchart of an embodiment of the present invention of a method for interpreting a metadata file that includes relationships.

FIG. 7 is a flow chart of an embodiment of the present invention of a method for preparing a client to go offline.

FIG. 8 is a work flow diagram of an embodiment of the present invention of a method of version control for a mobile computing environment.

FIG. 9 is a work flow diagram of an embodiment of the present invention of a method of updating data collected offline.

### DETAILED DESCRIPTION

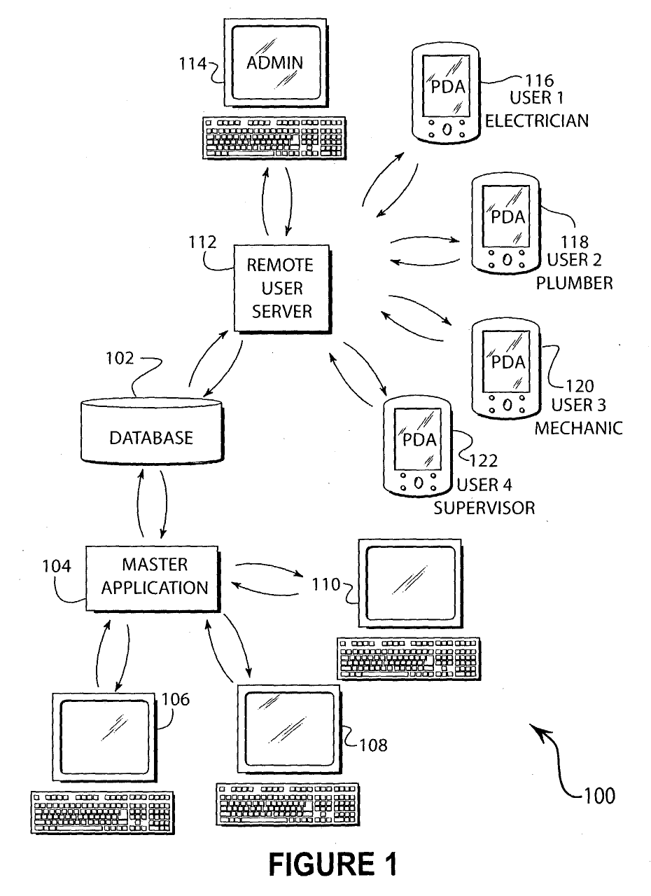

FIG. 1 is an illustration of a maintenance database system 100 wherein a database 102 is accessed using a master application 104. The master application 104 has several users 106, 108, and 110 on desktop computers. A remote user server 112 interfaces the database 102 to several other users, including an administrative user 114, an electrician 116, a plumber 118, a mechanic 120, and a supervisor 122. The administrative user 114 is accessing the remote user server 112 using a desktop computer while users 116, 118, 120, and 122 are accessing the server 112 and ultimately the database 102 through hand held computers.

The database 102 and master application 104 may be a large system for the management of factory maintenance. Such a database and master application may be a computerized maintenance management system such as MAXIMO, sold by MRO Software. Other applications may include databases directed toward client management, accounting, production management and inventory control, construction management, or any other database wherein several disparate users have various needs for data.

The remote user server 112 may access the database 102 directly and not go through the master application 104. In some cases, the master application 104 may provide connection points to the database 102 through which the server 112 may access data. The remote user server 112 takes data from the database 102 and prepares the data for the various end users 116, 118, 120, and 122. The server 112 may then take the modified data and pass it back to the database 102. The administrator 114 may configure the remote user server 112 for its various functions.

Each user 116, 118, 120, and 122 has different needs for the data. Further, each one may be able to change various fields of data and add or delete portions of data. Each user may use a hand held computer that has a limited screen size and limited data entry capability. For each user to be efficient at their jobs, it would be advantageous to provide just the data that each user needs and to provide an efficient and effective data collection mechanism.

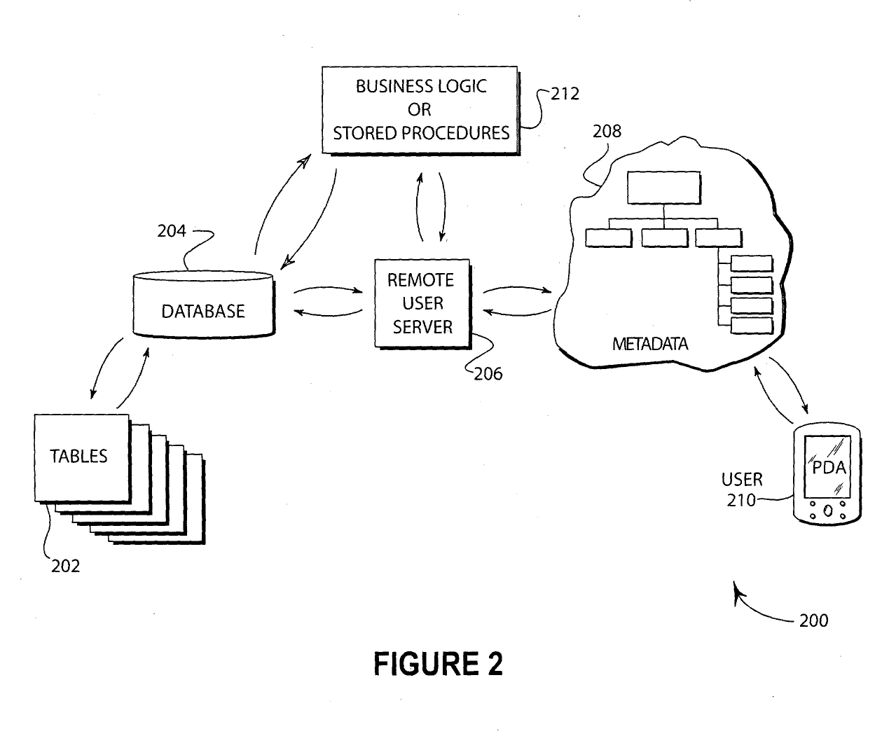

FIG. 2 illustrates a transformation 200 of data that is made between the user and the raw data. The raw data is stored in tables 202 and accessed by the database program 204 in a typical relational database. The remote user server 206 creates metadata 208 that is sent to the user 210. Once the metadata 208 is loaded, the data from the database 204 is then loaded to the user 210. The metadata 208 may be the structure and attributes of the data that is displayed.

Transactions made from the user 210 to the database 204. In some cases, direct queries for information may be generated at the user 210, passed directly through the remote user server 206 to the database 204. In other cases, such as during update, insert, and delete operations, the remote user server 206 may pass the queries through a set of business logic or stored procedures 212 before being sent to the database 204.

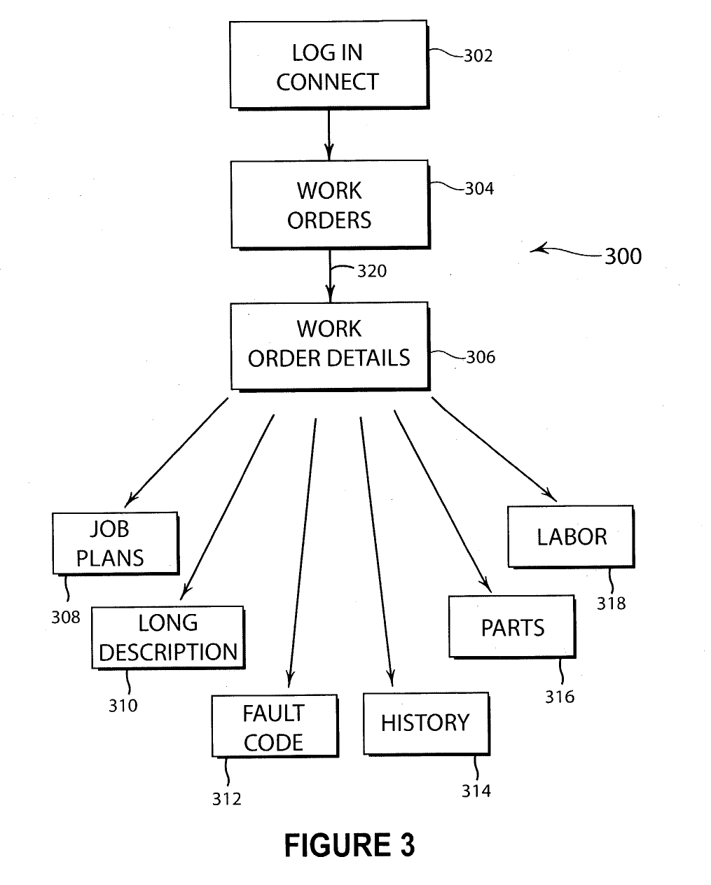

FIG. 3 illustrates an embodiment 300 of several sets of metadata for an application of a factory maintenance system. For the purposes of this specification, the term view shall be used to describe the metadata for a specific screen that a user will engage. The view's metadata may include the descriptions of the various fields of the data to be displayed, the display settings, and the descriptions of the metadata relationships between various views. The metadata may further contain the parameters necessary to build a SQL query to the database, such as database 204 of FIG. 2. The login and connect view 302 may represent the metadata for the functions of establishing a connection to the database. The work orders view 304 may represent the metadata for the display, searching, and review of the work orders that may be assigned to the user. Work order details view 306 may contain the detailed description of the work order. Job plans view 308 may include the work instructions for performing a specific task that is included in a work order. Long description view 310 may contain a more detailed textual or other description of the work to be performed. Fault code view 312 may include the various codes for the faults associated with a piece of machinery. History view 314 may contain the history of problems and service of a piece of equipment referenced in the work order. Parts view 316 may include the necessary parts required to perform the tasks of the work order. Labor view 318 may contain the logged hours against the work order.

In the present example, a complex system of interrelated views is necessary for the tradesman on the factory floor to perform the various maintenance work orders. These views give the tradesman the necessary information to complete the task and collect the data required to complete and close out a work order. For example, several work orders may be assigned to an electrician, which will be viewed on the work order view 304. In the work order view 304, the electrician can sort the work orders by due date or other criteria and select one for execution. The work order view 304 has a metadata relationship 320 established with the work order details view 306 that allows the electrician to navigate to the work order details view 306.

The metadata relationship 320 may be defined as part of the work orders view 304. The metadata relationship 320 may contain the SQL query to be displayed using the metadata of the work order details view 306. In addition, certain configurable parameters such as the display characteristics of the work order details view 306 may also be included in the metadata relationship. Other configurable parameters may include changes to the subsequent or child relationships of the metadata of the work order details view 306. These examples of configurable parameters are meant for example only. Those skilled in the arts of computer programming and database design may use the configurable parameters of the metadata relationship for any imaginable use while keeping within the scope and spirit of the present invention.

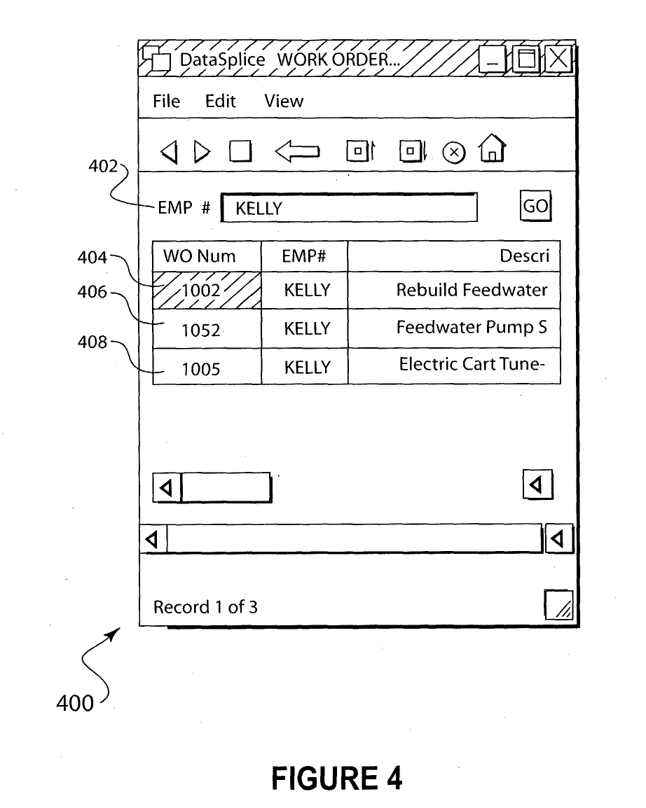

FIG. 4 illustrates a screen 400 of an embodiment of the work order view 304 of FIG. 3. For the employee 402, there are three records 404, 406, and 408 of work orders to perform. For the user to find more details for a specific work order, the user highlights, double clicks, or otherwise indicates the desired work order, such as work order 404 in the present figure.

The screen 400 is a typical embodiment of the size available on a hand held computer. The screen 400 as displayed on a hand held computer would typically cover the entire available screen space, leaving no room available for the user to switch between screens as would be common with a desktop computer using multiple windows. Further, the display device is typically a touch screen interface, and thus the display and input device must share the same real estate of the screen. These limitations of a hand held device are addressed in the present invention by minimizing the input required to navigate to useful data. Navigation is minimized by presenting only the most useful information to the user.

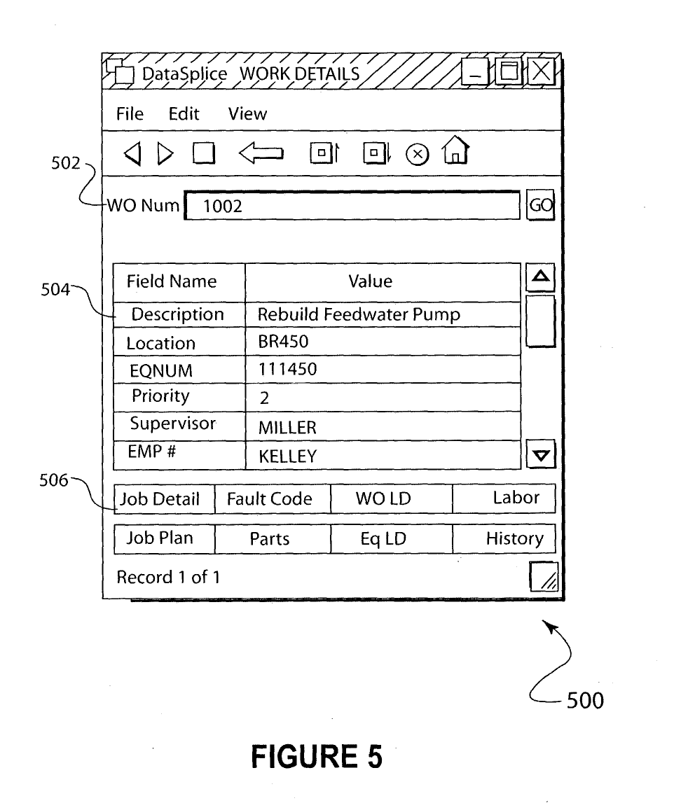

FIG. 5 illustrates a screen 500 of an embodiment of the work order details view 306 of FIG. 3. For the particular work order number 502, the various details 504 of the work order are displayed. The navigation buttons 506 are generated from the relationships contained in the work order details metadata.

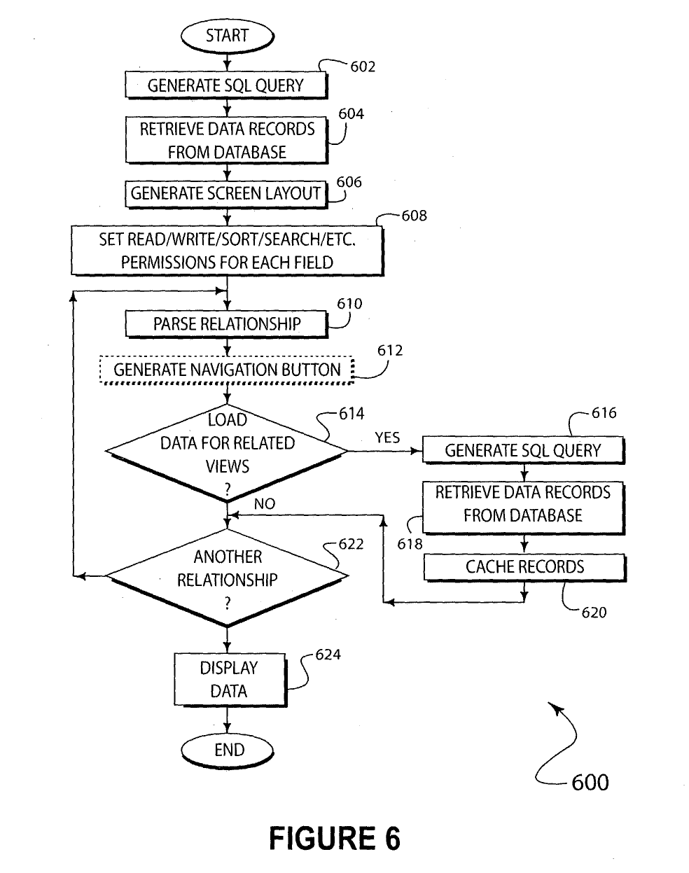

FIG. 6 is a flowchart of an embodiment 600 of a method for interpreting a metadata file that includes relationships. The metadata includes SQL parameters that are interpreted and an SQL query is generated in block 602. The data is retrieved from the database in block 604 based on the query. The parameters for the fields are interpreted and a screen layout is generated in block 606. The various permissions are assigned for each field in block 608. The metadata relationship is interpreted and parsed in block 610. If necessary, a navigation button or other screen effect may be created in block 612. The metadata relationship may have the option to have metadata relationship data loaded for dependent views in block 614. If so, the SQL query is generated in block 616 from the dependent view's metadata, the data retrieved in block 618, and cached in block 620. If more metadata relationships are present in block 622, the process is repeated. When the metadata relationships have been analyzed, the data for the present view is displayed in block 624.

The embodiment 600 describes a general methodology for a thin client to interpret and act upon the metadata of a particular view. In the present embodiment, the metadata may include the information necessary to generate an SQL query of the database, plus the information necessary to generate the screen layout and define the interface characteristics of each field. The client may interpret the metadata relationships to other views for various characteristics and act appropriately. In some cases, the metadata relationships may cause a navigation aid, such as a button, to be added to the screen display. In other cases, the metadata relationships may cause additional data to be loaded.

The metadata may have the command and query structure in order to generate a query from the database. The metadata may contain the actual SQL query or other query language to generate the data for the particular view, or the metadata may be interpreted into the commands necessary to directly query the database. In some cases, the thin client may issue a request to an intermediate server, such as the server 206 of FIG. 2 for analysis and action. When the SQL query is contained in the metadata, the query may be passed directly to the application database. The metadata may contain a different command language that may be interpreted and executed by the server. In some cases, the server may perform other functions for communication with the database such as security, protocols, requests for data, and caching of data. The server may also perform the aggregation and verification of data when the data is returned to the database.

The data of the related views may be loaded into the client memory through the metadata relationships. This method may allow a mobile computer, such as a hand held computer, to have useful data cached and ready to use when the mobile computer is detached from the network.

In other database applications using mobile computing, it may be customary to replicate the master database on each hand held computer and populate the hand held computer with the records that the user may need. In general, the master database may be very extensive with fields and functions that are used by many diverse users. By replicating the database on the hand held computer, much of the data that is stored on the hand held computer may not be useful to the particular end user. For example, a maintenance database may include accounting information that is not useful to an electrician trying to repair a broken pump. In another aspect of the prior art, the overhead and complexity of the replicated software takes up both memory space and processing capability of the limited hand held computer.

The present invention stores information contained in the views that are allowable for the particular user. The views for a particular user may be tailored for their needs. In such an embodiment, the caching of the data for each view a user may need represents all of the data that the user may need while minimizing the amount of unused and ultimately unneeded data. Such an embodiment allows more useful information to be stored on a mobile device than the embodiment wherein a portion of the database is replicated.

The use of a thin client that interprets the view metadata and allows navigation between views represents a very compact and efficient method of displaying and navigating data on a hand held computer. The thin client may not need substantial computing power to interpret the metadata and display the data. The complexities of running a relational database software product on a hand held may overtax the processing capacity of the hand held. In another aspect, the relational database may be limited in the amount of available memory on the hand held device.

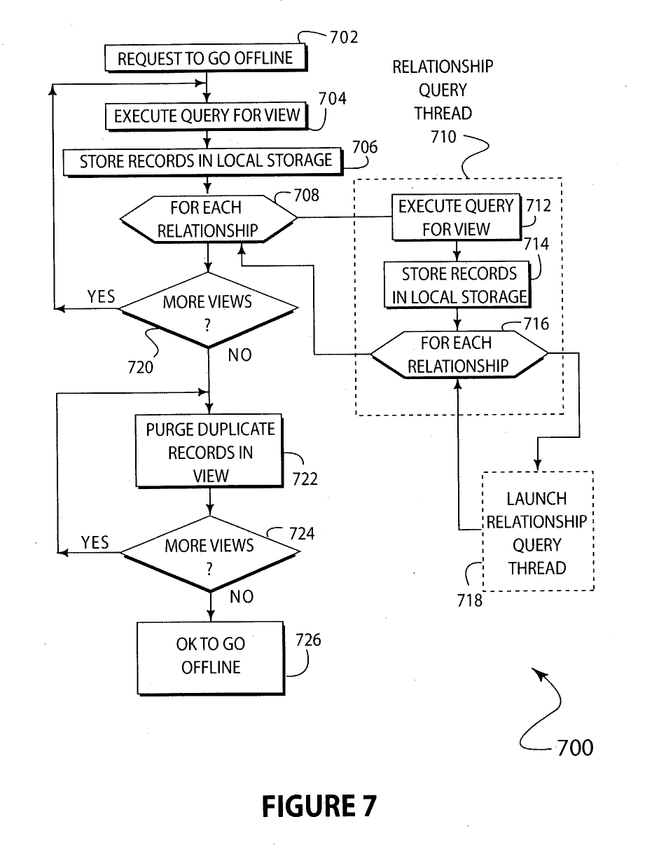

FIG. 7 is a flow chart of an embodiment 700 of a method for preparing a client to go offline. The embodiment 700 traverses through the tree of metadata by following each metadata relationship to a related view, generating the query for the individual views, and populating a local storage with the data records. After loading all of the data, redundant records may be purged from the local data storage.

The request to go offline in block 702 may be expressly initiated by a user or may be done automatically when a user logs on. For the first view, the SQL query is generated in block 704 and the records stored in the client's local storage in block 706. For each metadata relationship in block 708, a query thread is executed in block 710. The query thread in block 710 executes the query for the view in block 712 and stores the data locally in block 714. If the view has a metadata relationship in block 716, the query thread in block 718 is launched. The query thread in block 710 may be launched multiple times as needed to traverse the metadata tree. After all of the data are loaded into the local store, duplicate data are purged in block 724 for each view in block 724. After the data are purged, the client is OK to go offline in block 726.

In another embodiment, the server may keep a log of records sent to the mobile computer client. As queries are processed, the server may check the retrieved records against the log of records sent to the client. The server may then only transmit the new records to the client, thus keeping the memory use on the client to a minimum.

The embodiment 700 finds all of the useful information necessary for a user to perform their tasks while minimizing the unnecessary data stored locally. The views may be created with an emphasis on the data necessary to perform a certain series of tasks. The metadata relationships between the views may relate to the steps necessary to perform the tasks or may relate to the different tasks that are necessary for the user to execute their overall jobs. Traversing the metadata tree and collecting the information contained in all of the related views assures that all of the necessary information needed by the user is present.

The metadata relationship may contain a variable that indicates that the view should be made available offline. The offline variable would cause the method 700 to be automatically executed for the particular view. Such a variable would be helpful for pre-loading a view and the view data. In other cases, the user may be able to flag a view for offline use, thus manually executing the method 700.

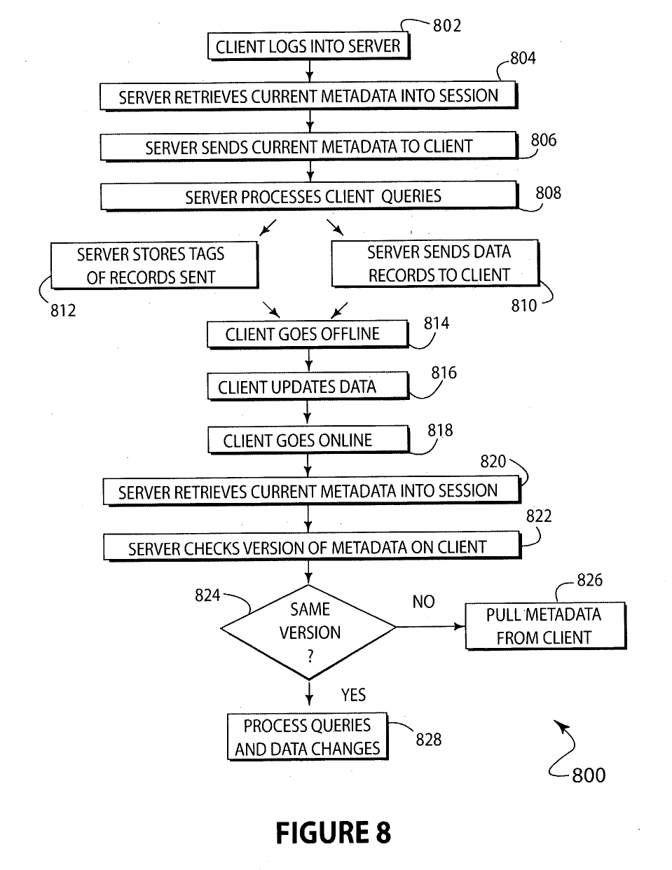

FIG. 8 is a work flow diagram of an embodiment 800 of a method of version control for a mobile computing environment. The client logs onto the server in block 802 and retrieves the current metadata into a session in block 804. The server sends the metadata to the client in block 806. At this point, both the client and server have the same metadata. This allows the communication between the client and server without conflicts. Problems may arise if the metadata on the server and client are different, such as the format of a data field may be different from what is expected, a field may be missing, or other differences.

The server processes the data requests from the client in block 808. The requests may include SQL queries to the master application database that are initiated by the client and optionally further processed by the server. The SQL queries may result in several database records that may be parsed and sent to the client in block 810. For each record sent to the client, the server may store a tag or identifier for that record in block 812. The client may go offline in block 814, update or change data in block 816, and return online in block 818.

When the client returns online, the server may retrieve the current metadata into a session in block 820 and request the version of the metadata from the client in block 822. The versions may be compared in block 824. If the versions are different, the server may pull the metadata from the client in block 826. If the versions are the same, the server and client may process queries and any data changes in block 828.

The process allows for changes to the metadata on the server. For example, if an administrator updates a view metadata on the server when the client is offline, the metadata between the server and client may be different. In that case, the client metadata may be pulled to the server. The client metadata may be used to transfer and interpret the data. In some cases, the data may require an intervention or special conflict resolution procedures to clarify any discrepancy. Such a procedure may involve querying the user or an administrator with one or more options to determine the proper course of action.

The server may store the tags of the records that are sent to the client in block 812. The server may check the list of record tags to see if the record had already been transmitted. This procedure may minimize the transmission of data from the server to the client and may have a beneficial impact in transmission time. The procedure of block 812 may be an alternative embodiment to block 722 of FIG. 7 wherein duplicate records are eliminated from the client data storage after transmittal.

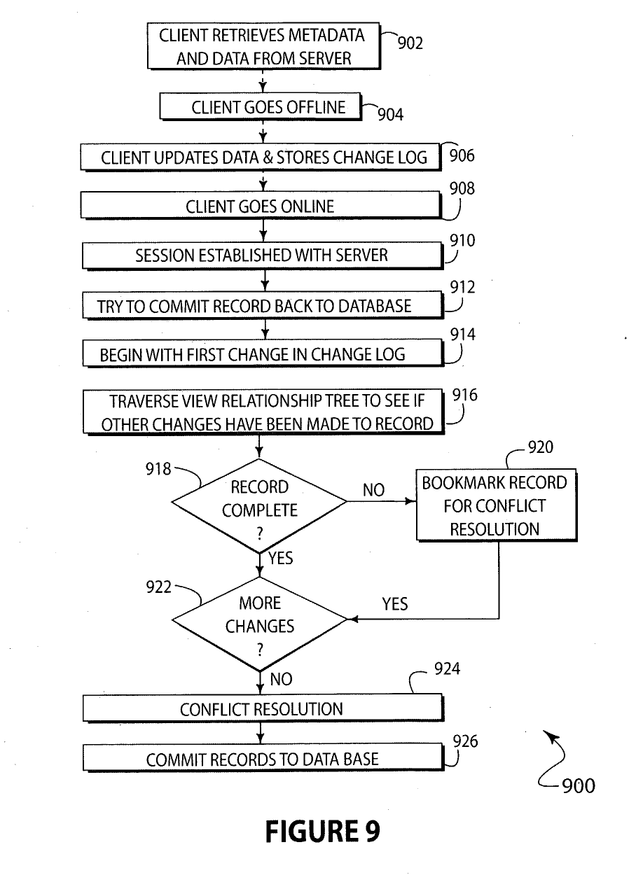

FIG. 9 illustrates a work flow diagram of an embodiment 900 of a method of updating data collected offline. The mobile client may retrieve metadata and data from the server in block 902, then go offline in block 904. While offline, the client may update the data and generate a change log in block 906. The client may go back online in block 908 and establish a session with the server 910. The session may be established as detailed in embodiment 800 of FIG. 8.

The server may try to commit a record back into the database in block 912, and may begin with the first change in the change log in block 914. From the first change, the server may traverse the metadata relationship tree to check for any other changes to that record in block 916. The record may be checked to be complete in block 918. If the record is not complete, a bookmark may be made on the record for conflict resolution in block 920. If more changes have not been processed in block 922, the process may be repeated.

The conflict resolution of block 924 may be a series of queries to the user for more information. In other embodiments, the conflict resolution may have some algorithm for determining a likely solution for the conflict. After the conflict is resolved, the records may be committed to the database in block 926. In some embodiments, all of the records may be committed in one step, while in other embodiments, each individual record may be committed when it is completed without waiting for all of the records to be complete.

The process of embodiment 900 uses the metadata relationships to quickly and efficiently collects all of the related information for each record by traversing the tree of metadata relationships. While the server traverses the tree of metadata relationships, it may encounter other changes to the record it is analyzing. These changes are tagged on the change log generated in block 906 as having been captured.

Metadata relationships establish the connections between several metadata structures that define views of data. All of the data in several related views may be from a single record in the master database or from multiple records. The metadata relationships allow an application designer or administrator to create a highly intricate connected structure of interrelated segments of data, but also facilitate the deconstruction of that data back to the individual records of the master application. By starting at an arbitrary point in the interrelated views, the server may traverse the tree of metadata relationships to collect any changes made to a particular record. The server may be able to completely capture the changes made to a particular record without having to analyze all of the changes in the change log or in all of the views. The interrelated views, as established by the metadata relationships, allows an administrator to quickly design an application without ‘hard coding’ or writing specific processes for handing the interdependencies of views.

The views and metadata relationships may be quickly and easily created without any hard coding. Since the metadata is interpreted by the thin client, and the metadata relationships are sufficient to fully define the interaction between views, features such as navigation routines, data dependencies, offline data availabilities, and other features may be fully defined without hard coding. For example, as metadata is loaded for a view, the navigation functions defined in the metadata relationships of the view may be sufficient for the client to generate navigation buttons or other navigation aids without hard coding. If a metadata relationship is added to the view, the next time a view is loaded another navigation button may appear.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A system for using data from a database comprising:
at least one client computer;
a server computer in communication with said database and said client computer;
a plurality of views defined by a plurality of metadata structures, each of said metadata structures comprising:
at least one displayable field of said database to be displayed by said view;
a query adapted to extract view data from said database to populate said view; and
at least one relationship comprising at least one link to another of said plurality of views;
a server program adapted to operate on said server computer and for each of said plurality of views, execute said query to extract view data from said database and store said view data on said client computer in a data container, said view data being arranged in said data container in accordance with said plurality of metadata structures;
a client program adapted to operate on said client computer and for each of said plurality of views, retrieve said view data from said data container and display said view data on said client computer in accordance with said plurality of views.

2. The system of claim 1 wherein said metadata structures further comprises at least one hidden field of said database that is not to be displayed by said view.

3. The system of claim 1 wherein said client program is further adapted to traverse from a first view to a second view by said relationship.

4. The system of claim 3 wherein a first relationship comprises a first query that references a second of said plurality of views that contains a second query, said first relationship further defining a subset of said second query.

5. The system of claim 1 wherein said server program is further adapted to retrieve data from said database by traversing from a first of said views to a second of said views by a relationship defined in the metadata defined in said first view.

6. The system of claim 5 wherein said traversing occurs in a recursive fashion.

7. The system of claim 1 wherein said client program is further adapted to display data from said data container by traversing from a first of said views to a second of said views by a relationship defined in the metadata defined in said first view.

8. The system of claim 1 wherein said client program is further adapted to determine that a relationship exists between a first of said views to a second of said views and to display a navigation button to said second of said views when said first of said views is displayed.

9. A method for using data from a database comprising:
providing at least one client computer;
providing a server computer in communication with said database and said client computer;
defining a plurality of views defined by a plurality of metadata structures, each of said metadata structures comprising:
at least one displayable field of said database to be displayed by said view;
a query adapted to extract view data from said database to populate said view; and
at least one relationship comprising at least one link to another of said plurality of views;
for each of said plurality of views, executing said query to extract view data from said database and storing said view data on said client computer in a data container, said view data being arranged in said data container in accordance with said plurality of metadata structures;
retrieving said view data from said data container using said client computer; and
displaying said view data on said client computer in accordance with said plurality of views.

10. The method of claim 9 wherein said metadata structures further comprises at least one hidden field of said database that is not to be displayed by said view.

11. The method of claim 9 further comprising traversing from a first view to a second view by said relationship using said client computer.

12. The method of claim 11 further comprising defining a first relationship comprises a first query that references a second of said plurality of views that contains a second query, said first relationship further defining a subset of said second query.

13. The method of claim 9 wherein said step of retrieving said view data further comprises traversing from a first of said views to a second of said views by a relationship defined in the metadata defined in said first view

14. The method of claim 13 wherein said traversing is performed in a recursive fashion.

15. The method of claim 9 wherein said step of displaying said view data further comprises traversing from a first of said views to a second of said views by a relationship defined in the metadata defined in said first view to display the data defined in said second of said views.

16. A method for displaying data on a remote computer comprising:
establishing a communication link between said remote computer and a server computer connected to a first database;
providing a plurality of views, each of said views defined by a metadata structure comprising a query and one or more fields;
providing at least one relationship defining a link from a first of said plurality of views to a second of said plurality of views;
executing said query of said first of said plurality of views against said database to collect first data;
traversing from said first of said plurality of views to said second of said plurality of views using said at least one relationship;
executing said query for said second of said plurality of views against said database to collect second data;
storing said first data and said second data in a second database accessible to said remote computer;
ending said communications between said remote computer and said server computer;
displaying at least a portion of said second database using said first of said plurality of views;
traversing to said second of said plurality of views using said relationship; and
displaying at least a portion of said second database using said second view.

17. The method of claim 16 wherein said query is an SQL query.

18. The method of claim 16 further comprising:
determining within a currently displayed view that said relationship exists between said first of said plurality of views and said second of said plurality of views; and
displaying a navigation button based on said relationship, said navigation button adapted to traverse to said second of said plurality of views.

19. The method of claim 16 wherein said step of displaying at least a portion of said second database using said first of said plurality of views is performed using a thin client on said remote computer
